(19) United States
(12) Patent Application Publication
(10) Pub. No.: US 2024/0193335 A1
(43) Pub. Date: Jun. 13, 2024

(54) ELECTRO-MECHANICAL MULTI-BOARD ASSEMBLY AND PLACEMENT COLLABORATION

(71) Applicant: Siemens Industry Software Inc., Plano, TX (US)

(72) Inventors: Gerald P. Suiter II, Madison, AL (US); David Thompson, Madison, AL (US)

(73) Assignee: Siemens Industry Software Inc., Plano, TX (US)

(21) Appl. No.: 18/556,207

(22) PCT Filed: May 4, 2021
(86) PCT No.: PCT/US2021/030617

§ 371 Date: Oct. 19, 2023

(51) Int. Cl. G06F 30/337

(52) U.S. Cl. CPC G06F 30/337

(57) ABSTRACT

This application discloses a computing system implementing a shared management system (340) to distribute virtual product models (343), each corresponding to a shared product model (341) describing a product having an electronic device with multiple printed circuit boards, to multiple printed circuit board layout tools (320-1 to 320-N). The printed circuit board layout tools (320-1 to 320-N) separately modify the corresponding virtual product models (343) to generate layout designs for the multiple print circuit boards and generate at least one system-level design rule describing a physical limitation for the electronic device. The shared management system (340) can update the shared product model (341) based on the modifications to at least one of the virtual product models by the printed circuit board layout tools (320-1 to 320-N), and transmit a notification (347) to at least one of the printed circuit board layout tools when the updated shared product model (341) conflicts with the physical limitation for the electronic device described in the at least one system-level design rule.

### TECHNICAL FIELD

This application is generally related to electronic design automation and, more specifically, to electro-mechanical multi-board assembly and placement collaboration.

### BACKGROUND

The development of electronic devices with printed circuit boards typically involves many steps, known as a design flow. This design flow typically starts with a specification for a new circuit to be implemented with a printed circuit board. The specification of the new circuit can be transformed into a circuit design, such as a netlist, for example, by a schematic capture tool or by synthesizing a logical circuit design, sometimes referred to as a register transfer level (RTL) description of the circuit. The netlist, commonly specified in an Electronic Digital Exchange Format (EDIF), can describe nets or connectivity between various devices or instances in the circuit design.

The design flow continues by verifying functionality of the circuit design, for example, by simulating or emulating the circuit design and verifying that the results of the simulation or emulation correspond with an expected output from the circuit design. The functionality also can be verified by statically checking the circuit design for various attributes that may be problematic during operation of an electronic device built utilizing the circuit design.

Once the circuit design has been functionally verified, the design flow continues to design layout and routing, which includes placing and interconnecting various components or parts into a layout representation of a printed circuit board. This procedure can be implemented in many different ways, but typically, through the use of a layout tool, which can present a graphical view of the printed circuit board and allow a designer to drag or place parts from a library onto the layout representation of the printed circuit board. The layout tool can validate the electronic device and perform various design rule checks on placed parts to ensure that the electronic device can be effectively built.

Since many electronic devices made on printed circuit boards will be included within a product, the layout of the printed circuit board may be constrained to ensure the product can be effectively manufactured. For example, the industrial or mechanical design of the product can define space available for the electronic device to be housed in the product. Due to the space limitations in the product, the design teams typically implement the electronic device using multiple printed circuit boards, often having space-limited configurations relative to each other and the housing of the product.

Design teams typically isolate the development of each layout of the printed circuit boards used to implement the electronic device and then resolve any incongruence between the developed printed circuit board layouts on an ad hoc basis. The separate design teams can each collect mechanical constraints corresponding to the industrial or mechanical design of the product and physical constraints of the other printed circuit board being separately developed, and then use these constraints to separately verify their layout designs of the printed circuit boards. To reconcile physical collisions between components on differing boards, for example, when arranged in a sandwich configuration, design teams often build models of the printed circuit board layouts or 3-D print them to ascertain whether layouts designs of printed circuit boards can be used to implement the electronic device inside of the product without physical overlap. Design teams also can utilize the collected constraints to manually account for varying electrical requirements across the differing printed circuit board layouts. For example, since certain components or wires on the printed circuit boards may have sufficient voltage to cause a safety issue if they are placed too close to other electronics or metal housing structures, the design teams can separately review the printed circuit board layout designs developed by other design teams to identify components having those voltage levels and then subjectively space components on their own layout design to avoid the safety concern in the overall design. These ad hoc measures to avoid physical incongruence and safety issues can lead the isolated design teams having to iterate the generation of their respective layout designs until they are resolved.

### SUMMARY

This application discloses a computing system implementing a shared management system to distribute virtual product models to multiple printed circuit board layout tools. The virtual product models can each correspond to a shared product model describing a product having an electronic device with multiple printed circuit boards. The printed circuit board layout tools separately modify the corresponding virtual product models to generate layout designs for the multiple print circuit boards in the product and to generate at least one system-level design rule describing a physical limitation for the electronic device based on a constraint in at least one of the layout designs for the multiple print circuit boards. The shared management system can update the shared product model based, at least in part, on the modifications to at least one of the virtual product models by the printed circuit board layout tools, and transmit a notification to at least one of the printed circuit board layout tools when the updated shared product model conflicts with the physical limitation for the electronic device described in the at least one system-level design rule. Embodiments will be described below in greater detail.

### DESCRIPTION OF THE DRAWINGS

FIGS. 1 and 2 illustrate an example of a computer system of the type that may be used to implement various embodiments.

FIG. 3 illustrates an example of a design system with a shared management system according to various embodiments.

FIG. 4 illustrates an example of a printed circuit board layout tool according to various embodiments.

FIG. 5 illustrates an example flowchart for centralized management of product-level design for a product having multiple printed circuit boards according to various embodiments.

FIG. 6 illustrates an example flowchart for centralized collaboration by a printed circuit board layout tool in a product-level design environment according to various embodiments.

### DETAILED DESCRIPTION

### Illustrative Operating Environment

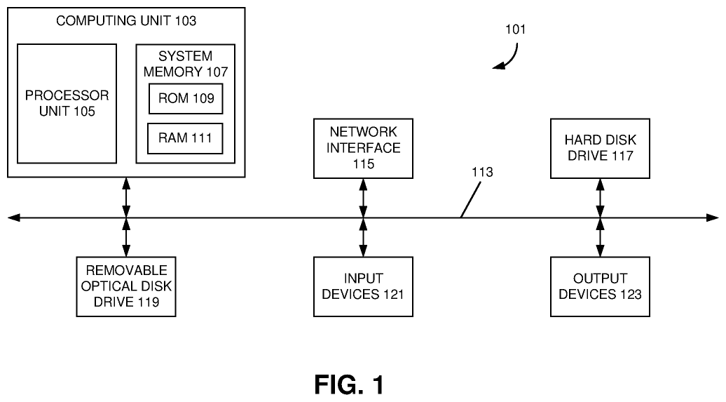

Various examples may be implemented through the execution of software instructions by a computing device 101, such as a programmable computer. Accordingly, FIG. 1 shows an illustrative example of a computing device 101. As seen in this figure, the computing device 101 includes a computing unit 103 with a processor unit 105 and a system memory 107. The processor unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processor unit 105.

The processor unit 105 and the system memory 107 are connected, either directly or indirectly, through a bus 113 or alternate communication structure, to one or more peripheral devices 115-123. For example, the processor unit 105 or the system memory 107 may be directly or indirectly connected to one or more additional memory storage devices, such as a hard disk drive 117, which can be magnetic and/or removable, a removable optical disk drive 119, and/or a flash memory card. The processor unit 105 and the system memory 107 also may be directly or indirectly connected to one or more input devices 121 and one or more output devices 123. The input devices 121 may include, for example, a keyboard, a pointing device (such as a mouse, touchpad, stylus, trackball, or joystick), a scanner, a camera, and a microphone. The output devices 123 may include, for example, a monitor display, a printer and speakers. With various examples of the computing device 101, one or more of the peripheral devices 115-123 may be internally housed with the computing unit 103. Alternately, one or more of the peripheral devices 115-123 may be external to the housing for the computing unit 103 and connected to the bus 113 through, for example, a Universal Serial Bus (USB) connection.

With some implementations, the computing unit 103 may be directly or indirectly connected to a network interface 115 for communicating with other devices making up a network. The network interface 115 can translate data and control signals from the computing unit 103 into network messages according to one or more communication protocols, such as the transmission control protocol (TCP) and the Internet protocol (IP). Also, the network interface 115 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 101 is illustrated as an example only, and it not intended to be limiting. Various embodiments may be implemented using one or more computing devices that include the components of the computing device 101 illustrated in FIG. 1, which include only a subset of the components illustrated in FIG. 1, or which include an alternate combination of components, including components that are not shown in FIG. 1. For example, various embodiments may be implemented using a multi-processor computer, a plurality of single and/or multiprocessor computers arranged into a network, or some combination of both.

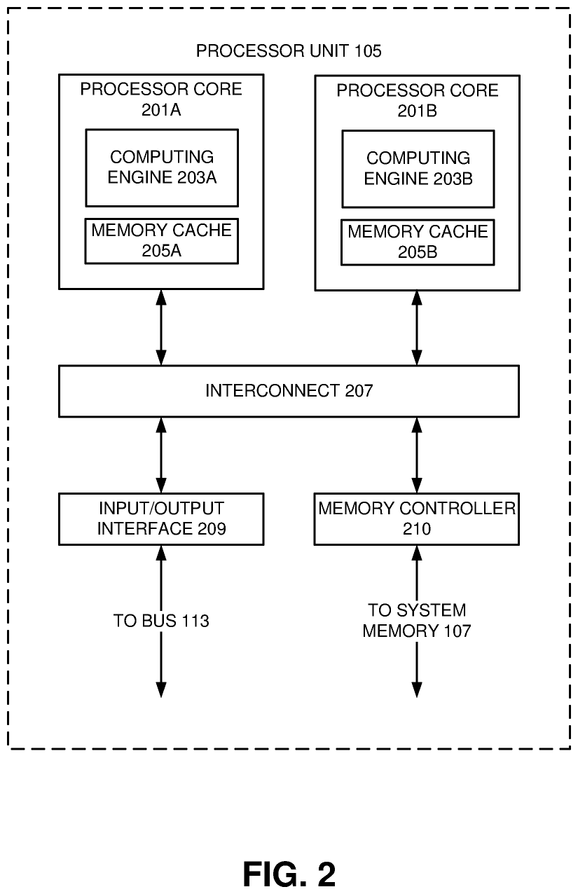

With some implementations, the processor unit 105 can have more than one processor core. Accordingly, FIG. 2 illustrates an example of a multi-core processor unit 105 that may be employed with various embodiments. As seen in this figure, the processor unit 105 includes a plurality of processor cores 201A and 201B. Each processor core 201A and 201B includes a computing engine 203A and 203B, respectively, and a memory cache 205A and 205B, respectively. As known to those of ordinary skill in the art, a computing engine 203A and 203B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203A and 203B may then use its corresponding memory cache 205A and 205B, respectively, to quickly store and retrieve data and/or instructions for execution.

Each processor core 201A and 201B is connected to an interconnect 207. The particular construction of the interconnect 207 may vary depending upon the architecture of the processor unit 105. With some processor cores 201A and 201B, such as the Cell microprocessor created by Sony Corporation, Toshiba Corporation and IBM Corporation, the interconnect 207 may be implemented as an interconnect bus. With other processor units 201A and 201B, however, such as the Opteron™ and Athlon™ dual-core processors available from Advanced Micro Devices of Sunnyvale, California, the interconnect 207 may be implemented as a system request interface device. In any case, the processor cores 201A and 201B communicate through the interconnect 207 with an input/output interface 209 and a memory controller 210. The input/output interface 209 provides a communication interface to the bus 113. Similarly, the memory controller 210 controls the exchange of information to the system memory 107. With some implementations, the processor unit 105 may include additional components, such as a high-level cache memory accessible shared by the processor cores 201A and 201B. It also should be appreciated that the description of the computer network illustrated in FIG. 1 and FIG. 2 is provided as an example only, and is not intended to suggest any limitation as to the scope of use or functionality of alternate embodiments.

### Electro-Mechanical Multi-Board Assembly and Placement Collaboration

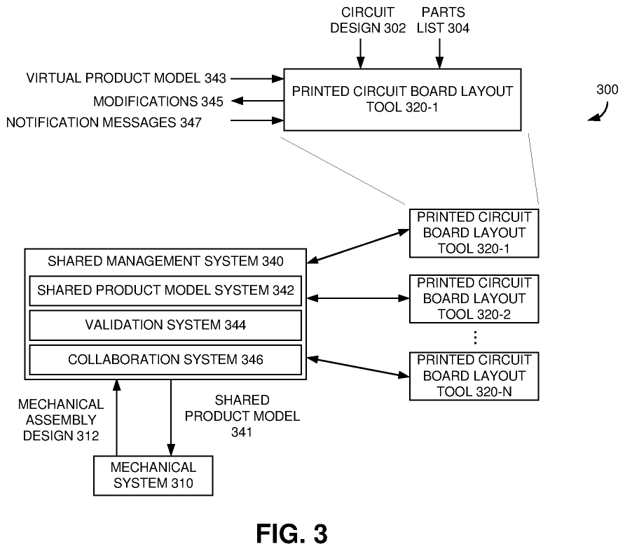

FIG. 3 illustrates an example of a design system 300 including a shared management system 340 according to various embodiments. Referring to FIG. 3, the design system 300 can be a distributed design environment, which allows different aspects of product design to be performed by different communicating tools or systems. For example, the design system 300 can include a mechanical system 310 to develop a mechanical assembly design 312 for a product, and a plurality of printed circuit board layout tools 320-1 to 320-N to each develop a board assembly design of a different printed circuit board for an electronic device, which can be included in the product. The shared management system 340 in the design system 300 can generate a shared product model 341 that aggregates the mechanical assembly design 312 from the mechanical system 310 and the board assembly designs from the printed circuit board layout tools 320-1 to 320-N into a product-level representation for use by the printed circuit board layout tools 320-1 to 320-N during product development in the distributed design environment.

The mechanical system 310 can provide the mechanical assembly design 312 to the shared management system 340 in the design system 300. The mechanical assembly design 312 can describe various physical design elements associated with the product, such as a design for a housing of the product. In some examples, the design for the housing can include locations and dimensions of electronic system(s) and physical interfaces, such as a display device, a touchscreen, an image capture device, input/output devices, electrical ports, audio devices, or the like. The mechanical assembly design 312 also can describe physical mounting information for the physical interfaces and electronic system(s), describe physical connectivity of the physical interfaces and electronic system(s) to each other and to the housing of the product, describe a presence of mechanical heat dissipation devices in the product, or the like.

The mechanical system 310 can provide the shared management system 340 with the mechanical assembly design 312 at any point during the design process, for example, through an exchange of design files in the form of STEP (Standard for the Exchange of Product model data) and/or SAT (Standard ACIS Text) files. The format of a STEP file, in some embodiments, can be defined in (International Organization for Standardization) ISO 10303-21, entitled “Industrial automation systems and integration—Product data representation and exchange—Part 21: Implementation methods: Clear text encoding of the exchange structure.”

The shared management system 340 can include a shared product model system 342 to generate a shared product model 341 that aggregates the mechanical assembly design 312 from the mechanical system 310 and the board assembly designs from the printed circuit board layout tools 320-1 to 320-N into the product-level representation. When the mechanical assembly design 312 received from the mechanical system 310 corresponds to an update of a previously received version of the mechanical assembly design 312, the shared product model system 342 can update the shared product model 341 based on the updates in the mechanical assembly design 312 received from the mechanical system 312. In some embodiments, the shared product model system 342 can provide the mechanical system 310 with the shared product model 341 at any point during the design process, for example, through an exchange of design files in the form of STEP (Standard for the Exchange of Product model data) and/or SAT (Standard ACIS Text) files.

The shared product model system 342 can distribute the shared product model 341 to the printed circuit board layout tools 320-1 to 320-N as virtual product models 343. Both the virtual product models 343 and the shared product model 341 can describe the product having an electronic device with multiple printed circuit boards being developed by the design system 300. The printed circuit board layout tools 320-1 to 320-N can utilize the virtual product models 343 during the generation of the board assembly designs that describe a different printed circuit board of the electronic device for the product in terms of various components placed and interconnected on a representation of the printed circuit boards. In some embodiments, the printed circuit board layout tools 320-1 to 320-N can modify the virtual product models 343 to suggest changes to the mechanical assembly design 312, including locations in a product for one or more printed circuit boards. The printed circuit board layout tools 320-1 to 320-N can provide the suggested changes to the mechanical assembly design 312 to the shared management system 340, which can transmit them to the mechanical system 310, for example, through a transmission of one or more design files in the form of STEP and/or SAT files.

The printed circuit board layout tools 320-1 to 320-N can each provide a design environment allowing for a layout of a corresponding circuit design 302 into a board assembly design, for example, by placing parts or components from a parts list 304 onto the representation of printed circuit boards. The printed circuit board layout tools 320-1 to 320-N can modify the virtual product model 343 to include the board assembly design developed or being developed by the printed circuit board layout tools 320-1 to 320-N and provide those modifications 345 to the shared management system 340.

The printed circuit board layout tools 320-1 to 320-N can perform various design rule checks on the board assembly design to determine whether the updates in the board assembly design violate any design rules. For example, the printed circuit board layout tool 320 can review locations and characteristics of component models placed in the representation of the printed circuit board to determine whether the component models, as placed, conform to the design rules. The printed circuit board layout tools 320-1 to 320-N can update the representation of the printed circuit board, for example, to illustrate the placement of a selected part or route of a trace line and highlight conformance or lack thereof with at least one of the design rules, which can be displayed or presented by a display device.

The virtual product model 343 can include system-level design rules that indicate constraints one or more of the mechanical assembly design 312 or a board assembly design imposes on the development of the electronic device by the printed circuit board layout tools 320-1 to 320-N. The system-level design rules can correspond to physical limitations associated with a physical constraint in the mechanical assembly design 312 or a board assembly design. For example, when two printed circuit boards in the electronic device have a sandwich configuration, i.e., where the printed circuit boards have a parallel orientation with their components facing each other, a placement of one component in a layout design of one of the printed circuit boards can impose a limitation on the height of components on the other printed circuit board. In another example, a placement of a higher voltage component in a layout design of one of the printed circuit boards can impose a distance limitation for other components on other printed circuit boards in the electronic device to avoid a safety related issue of voltage jumps between printed circuit boards. The virtual product model 343 can include system-level design rules corresponding to the physical constraints imposed the mechanical assembly design 312 and the development of the board assembly designs.

The printed circuit board layout tools 320-1 to 320-N can separately modify the corresponding virtual product model 343 with the board assembly design being developed and provide the modifications 345 to the shared management system 340. In some embodiments, one of the printed circuit board layout tools 320-1 to 320-N can identify when one or more portions of the board assembly design being developed would limit development of another one of the printed circuit board layout tools 320-1 to 320-N and modify the virtual product model 343 to include a new system-level design rule for the developed board assembly design. Since the virtual product models 343 can provide a product-level representation to the printed circuit board layout tools 320-1 to 320-N during the separate development of their respective board assembly designs, each of the printed circuit board layout tools 320-1 to 320-N can alter the virtual product model 343 corresponding to a board assembly design begin developed by a different printed circuit board layout tool 320-1 to 320-N. For example, the printed circuit board layout tool 320-1 can identify a modification 345 to be made to a board assembly design being developed by the printed circuit board layout tools 320-N, select a component in or a portion of that board assembly design, and then identify an alteration for the selected component or portion, such as altering a placement location, rotate the selected component or portion, or the like. The printed circuit board layout tool 320-1 can utilize the identified alteration as a suggested change to that board assembly design, which the printed circuit board layout tool 320-1 can output as one of the modifications 345 to the virtual product model 343. The shared product model system 342 can update the shared product model 341 based on the modifications 345 received from one or more of the printed circuit board layout tools 320-1 to 320-N. In some embodiments, the shared product model system 342 also can identify the suggested changes in the modifications 345 and provide those suggested changes in one or more notification messages 347 to the respective printed circuit board layout tools 320-1 to 320-N, where the printed circuit board layout tools 320-1 to 320-N can display the suggested changes visually for the designers to consider and/or implement.

In some embodiments, the shared management system 340 can include a validation system 344 to perform one or more design rule checks on the shared product model 341 based on the system-level design rules. The validation system 344 can perform the design rule checks by comparing the various physical limitations imposed by the system-level design rules against the shared product model 341 as updated by the modifications 345. The validation system 344 can identify when one or more of the modifications 345 violated an existing system-level design rule or when a new system-level design rule caused a conflict or a limitation to another portion of the shared product model 341, such as another board assembly design or the mechanical assembly design 312.

The shared management system 340 includes a collaboration system 346 to generate notification messages 347 for the printed circuit board layout tools 320-1 to 320-N and optionally the mechanical system 310. The notification messages 347, in some embodiments, can indicate that a new version of the shared product model 341 has become available for distribution as a virtual product model 343 to the printed circuit board layout tools 320-1 to 320-N. The notification messages 347 can identify a conflict with a board assembly design begin developed by one of the printed circuit board layout tools 320-1 to 320-N and the new version of the shared product model 341. In some embodiments, the notification messages 347 can indicate a portion of the board assembly design having a conflict in the new version of the shared product model 341 and possibly suggesting a modification to the board assembly design that could resolve the conflict. As discussed above, the suggested modification to the board assembly design can be generated by one of the printed circuit board layout tools 320-1 to 320-N, with the collaboration system 346 forwarding the suggested modification to the respective printed circuit board layout tools 320-1 to 320-N for consideration and/or implementation.

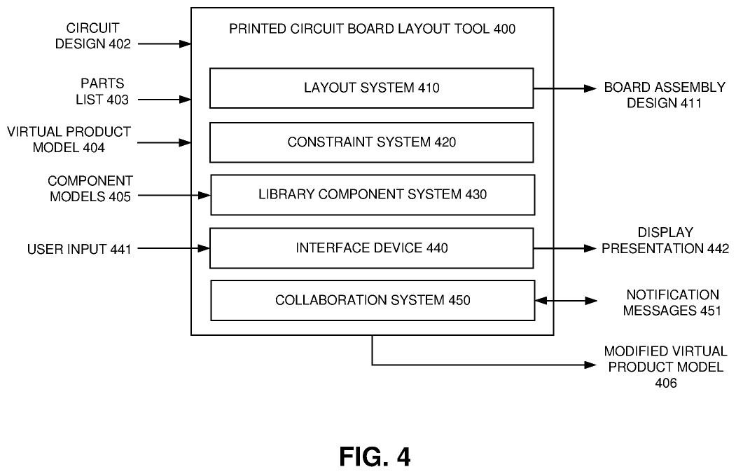

FIG. 4 illustrates an example of a printed circuit board layout tool 400 according to various embodiments. Referring to FIG. 4, the printed circuit board layout tool 400 can include a layout system 410 to layout a circuit design 402 with parts from a parts list 403, which generates a board assembly design 411. The circuit design 402, such as a netlist, can describe components in an electronic device and the connectivity of those components to each other. In some embodiments, the netlist can be generated by a schematic capture tool or by synthesizing a logical circuit design, sometimes referred to as a register transfer level (RTL) description of the circuit. The netlist can be specified in an Electronic Digital Exchange Format (EDIF), which can describe nets or connectivity between various components or instances in the circuit design 402. The parts list 403 can include multiple parts that can correspond to the components described in the circuit design 402. Although FIG. 4 shows the printed circuit board layout tool 400 receiving the circuit design 402 and the parts list 404, in some embodiments, the printed circuit board layout tool 400 can generate the circuit design 402 and/or parts list 404 internally.

The printed circuit board layout tool 400 can identify constraints from a virtual product model 404, for example, received from a shared management system. The virtual product model 404 can include a description for the design of the product that includes board assembly design 411 developed by the printed circuit board layout tool 400. For example, the virtual product model 404 can include information on a mechanical assembly of the product and the electronic device having multiple printed circuit boards included in the product. The printed circuit board layout tool 400 can receive updates to the virtual product model 404, such as changes to the mechanical assembly, printed circuit boards, or system-level design rules, during the development of the product by the other design tools in the distributed design system.

The printed circuit board layout tool 400 can include constraint system 420 to analyze the virtual product model 404 to identify constraints that can limit or constrain layout of the circuit design 402 into the board assembly design 411. In some embodiments, the constraints can include a description of an enclosure that the board assembly design 411 is to fit into, locations and description of fasteners utilized to adhere a printed circuit board manufactured according to the board assembly design 411 to a housing described in the mechanical assembly design, presence and location of other mechanical devices, such as heat dissipation devices or physical interfaces in the mechanical assembly, or the like. The constraints can also include a description of components or wires placed other printed circuit boards in the product, which could have physical or electrical characteristics capable of limiting or constraining the layout of the circuit design 402 into the board assembly design 411.

The constraint system 420 can identify system-level design rules based on the electro-mechanical constraints identified or parsed from the virtual product model 404. The system-level design rules can correspond to the electro-mechanical constraints, such that when board assembly design 411 violates a system-level design rule, the board assembly design 411 would be inconsistent with the virtual product model 404 from which the electro-mechanical constraints were derived or identified. The printed circuit board layout tool 400 can incorporate or associate the system-level design rules developed by the constraint system 420 with a master set of design rules utilized by the printed circuit board layout tool 400 in design rule checks.

The printed circuit board layout tool 400 can include an interface device 440 to output a display presentation 442 that, when displayed by a display device, can provide a user interface to the design environment. The display presentation 442 can include a graphical display window including at least one layout representation of the board assembly design 411 from the layout system 410 and include various tools or embedded functionality that can allow placement of parts or components from the parts list 403 into the layout representation of the board assembly design 411.

The layout system 410 can initially represent the board assembly design 411 as a blank print circuit board, for example, having dimensions corresponding to one or more of the constraints gleaned from the virtual product model 404. The layout system 410 can receive user input 441, for example, based on the display presentation 442, which can prompt the layout system 410 to perform various updates to the data models corresponding to the board assembly design 411. In some embodiments, the user input 441 can identify a part selected from the parts list 403 and identify a location in the board assembly design 411 for placement of the selected part. The layout system 410 can place at least one component model that corresponds to the selected part in the data model corresponding to the identified location in the board assembly design 411, route traces between the placed parts based on the connectivity in the circuit design 402, or the like.

The printed circuit board layout tool 400 can include a library component system 430 to identify one or more component models 405 that correspond to the selected part. In some embodiments, the layout system 410 can provide an indication of the selected part to the library component system 430, and the library component system 430 can access a library (not shown) to identify a component model corresponding to the selected part capable of being placed in the board assembly design 411.

The layout system 410 can modify the virtual product model 404 to include a current version of the board assembly design 411 being developed by the printed circuit board layout tool 400, which generates a modified virtual product model 406. The printed circuit board layout tool 400 can transmit the modified virtual product model 406 to the shared management system for incorporation into the shared product model and subsequent distribution to other development tools in the design system for the product. In some embodiments, the layout system 410 can modify the virtual product model 404 to suggest changes to a mechanical design, including locations in a product for one or more printed circuit boards.

In some embodiments, the constraint system 420 can analyze the modification of the virtual product model 404 to identify whether to generate any new system-level design rules for incorporation into the modified virtual product model 406. The constraint system 420 can compare the modifications to the virtual product model 404 to identify a component, wire, or layout portion that has a height or electrical characteristics, which could cause a constraint or development restrictions to any of the other development tools in the design system for the product. For example, when the board assembly design 411 includes a higher voltage component, the constraint system 420 can determine a clearance around the higher voltage component to avoid voltage jumps and create a system-level design rule that constrains other development tools in the design system for the product from modifying their portion of the shared product model to include components within that clearance area. The constraint system 420 can incorporate the system-level design rules into the modified virtual product model 406 for transmission to the shared management system for incorporation into the shared product model and subsequent distribution to other development tools in the design system for the product.

The printed circuit board layout tool 400 can include a collaboration system 450 to exchange notification messages 451 with the shared management system. The notification messages 451, in some embodiments, can indicate that a new version of the shared product model has become available for distribution as a virtual product model 404 to the printed circuit board layout tool 400. The notification messages 451 can identify a conflict with a board assembly design 411 begin developed by the printed circuit board layout tool 400 and the new version of the shared product model. In some embodiments, the notification messages 400 can indicate a portion of the board assembly design 411 having a conflict in the new version of the shared product model and possibly suggesting a modification to the board assembly design 411 that could resolve the conflict. The collaboration system 450, in response to the notification messages 451 from the shared management system, can download the virtual product model 404, present any conflicts with the virtual product model 404 in the display presentation 442, or prompt the layout system 410 to enact the suggested modification to the board assembly design 411. In some embodiments, the collaboration system 450 can decline the suggested modification to the board assembly design 411 and instead modify the board assembly design 411 differently.

The collaboration system 450 also can generate notification messages 450 for transmission to other design tools in the design system via the shared management system. For example, the collaboration system 450 can decline the suggested modification to the board assembly design 411, and instead generate a notification message 451 having a suggested change to a different portion of the virtual product model to resolve the conflict.

The printed circuit board layout tool 400 also can analyze the layout representations for congruency with the design rules. For example, the layout system 410 can perform various design rule checks on the board assembly design 411 to determine whether the updates in the board assembly design 411 violate any design rules or their associated electro-mechanical constraints. The electro-mechanical constraints can include at least one electrical constraint or mechanical constraint for the board assembly design 411. In some embodiments, the layout system 410 can review locations and characteristics of component models placed in the data model of the board assembly design 411 to determine whether the component models, as placed, conform to the design rules. The layout system 410 can provide some granular user options for its design rule checking, for example, allowing user control over which portions of the board assembly design 411 to check for consistency with the design rules. For example, the layout system 410 can compare different portions of the printed circuit board described in the board assembly design 411, such as a printed circuit board assembly, a component on the printed circuit board, a bond wire on the printed circuit board, a particular portion of the printed circuit board itself, such as a board edge, or the like, with each other. The layout system 410 also can compare different portions of the printed circuit board described in the board assembly design 411 with other portions of the product, such as other printed circuit boards in the product, constraints derived or identified from the virtual product model 404, or the like.

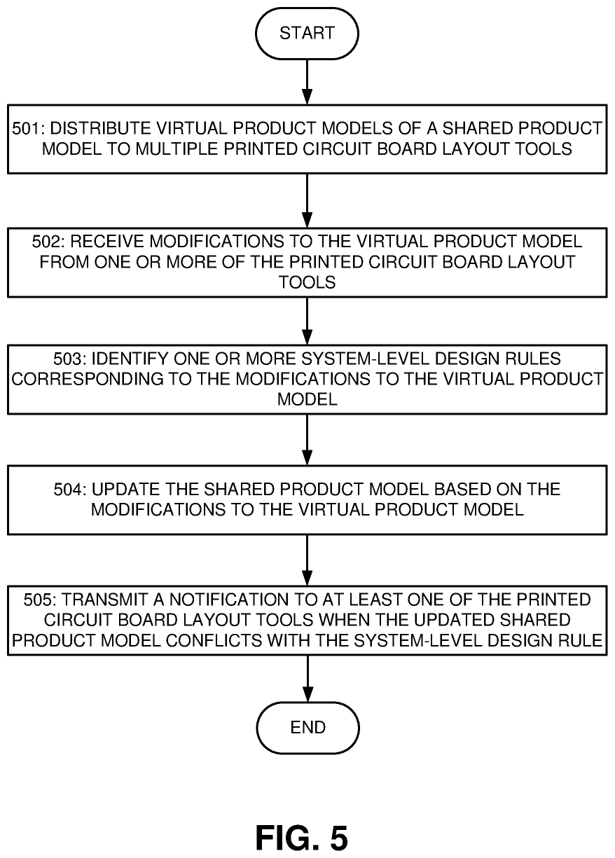

FIG. 5 illustrates an example flowchart for centralized management of product-level design for a product having multiple printed circuit boards according to various embodiments. Referring to FIG. 5, a computing device implementing a shared management system can distribute virtual product models of a shared product model to multiple printed circuit board layout tools. The shared management system can generate a shared product model that aggregates a mechanical assembly design of a product received from a mechanical system and multiple board assembly designs received from printed circuit board layout tools into the product-level representation. The shared management system can distribute the shared product model to the printed circuit board layout tools as virtual product models. Both the virtual product models and the shared product model can describe the product having an electronic device with multiple printed circuit boards being developed by the design system. The printed circuit board layout tools can utilize the virtual product models during the development of the board assembly designs for the electronic device of the product.

In a block 502, the computing device implementing the shared management system can receive modifications to the virtual product model from one or more of the printed circuit board layout tools. The printed circuit board layout tools can separately modify the virtual product model to include board assembly designs developed or in the process of being developed by the printed circuit board layout tools, and provide those modifications to the shared management system.

In a block 503, the computing device implementing the shared management system can identify one or more system-level design rules corresponding to the modifications to the virtual product model. The system-level design rules, in some embodiments, can correspond to physical limitations associated with a physical constraint in the mechanical assembly design or a board assembly design. In some embodiments, one of the printed circuit board layout tools can identify when one or more portions of the board assembly design being developed would limit development by another one of the printed circuit board layout tools and modify the virtual product model to include a new system-level design rule for the developed board assembly design. The shared management system can parse or otherwise identify the new system-level design rules in the modified version of the virtual product model provided to the shared management system.

In some embodiments, the shared management system can analyze the modifications to the virtual product model received from one of the printed circuit board layout tools to identify when one or more portions of the board assembly design being developed would limit development by another one of the printed circuit board layout tools and generate a new system-level design rule for the developed board assembly design.

In a block 504, the computing device implementing the shared management system can update the shared product model based on the modifications to the virtual product model. The shared management system, in some embodiments, can replace the shared product model for the modified virtual product model received from the printed circuit board layout tools. The shared management system can modify the shared product model by incorporating the modifications including the new system-level design rule into the shared product model.

In a block 505, the computing device implementing the shared management system can transmit a notification to at least one of the printed circuit board layout tools when the updated shared product model conflicts with the system-level design rule. The shared management system, in some embodiments, can receive the notification messages from the printed circuit board layout tools and forward them to one or more of the printed circuit board playout tools or the mechanical system of a new version of the shared product model, a design conflict within the shared product model, and/or a suggest change to the shared product model that can resolve the conflict.

The shared management system also can generate notification messages that inform one or more of the printed circuit board layout tools 400 that a new version of the shared product model has become available for distribution as a virtual product model to the printed circuit board layout tools. In some embodiments, the shared management system can analyze the updated version of the shared product model to identify any conflicts between the board assembly designs, conflicts with a board assembly design and the mechanical design, conflicts with a board assembly design or a mechanical design and a system-level design rule, or the like. The shared management system can generate one or more notification messages based on the identified conflicts, for example, to inform one or more of the printed circuit board playout tools or the mechanical system of the conflict. In some embodiments, the shared management system can identify suggested changes or modification to one or more of the designs having a conflict, which if implement, would resolve the conflict. The shared management system can generate one or more notification messages based on the identified suggested change, for example, to inform one or more of the printed circuit board playout tools or the mechanical system of an option to resolve the conflict.

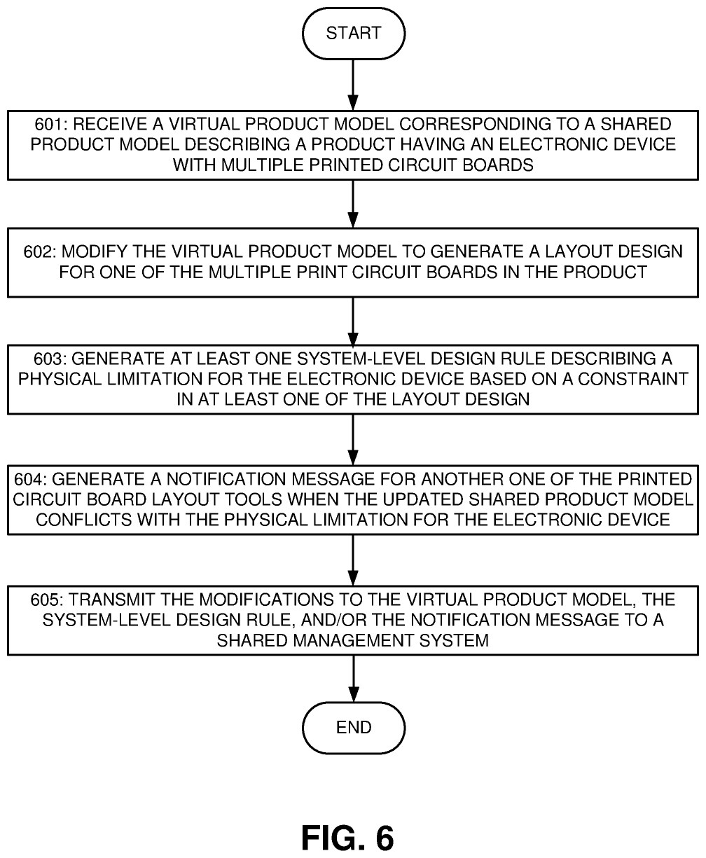

FIG. 6 illustrates an example flowchart for centralized collaboration by a printed circuit board layout tool in a product-level design environment according to various embodiments. Referring to FIG. 6, in a block 601, a computing system implementing a printed circuit board layout tool can receive a virtual product model corresponding to a shared product model describing a product having an electronic device with multiple printed circuit boards. The virtual product model can include a description for the design of the product that includes layout design developed by the printed circuit board layout tool. For example, the virtual product model can include information on a mechanical assembly of the product and the electronic device having multiple printed circuit boards included in the product. The printed circuit board layout tool can receive updates to the virtual product model, such as changes to the mechanical assembly, layout designs of the printed circuit boards, or system-level design rules, during the development of the product by the other design tools in the distributed design system.

In a block 602, the computing system implementing the printed circuit board layout tool can modify the virtual product model to generate a layout design for one of the multiple print circuit boards in the product. The printed circuit board layout tool can layout a circuit design with parts from a parts list, which generates the layout design. The circuit design, such as a netlist, can describe components in an electronic device and the connectivity of those components to each other. The printed circuit board layout tool can modify the virtual product model to include a current version of the layout design being developed by the printed circuit board layout tool.

In a block 603, the computing system implementing the printed circuit board layout tool can generate at least one system-level design rule describing a physical limitation for the electronic device based on a constraint in at least one of the layout design for one of the multiple print circuit boards in the product. The printed circuit board layout tool can analyze the modification of the virtual product model to identify whether to generate any new system-level design rules. In some embodiments, the printed circuit board layout tool can compare the modifications to the virtual product model to identify a component, trace, or layout portion that has a height or electrical characteristics, which could cause a constraint or development restrictions to any of the other development tools in the design system for the product. The printed circuit board layout tool can incorporate the system-level design rules into the modified version of the virtual product model

In a block 604, the computing system implementing the printed circuit board layout tool can generate a notification message to another one of the printed circuit board layout tools when the updated shared product model conflicts with the physical limitation for the electronic device described in the at least one system-level design rule.

The printed circuit board layout tool can determine that the modifications to the virtual product model via the generation of the layout design of the printed circuit board or the generation of the system-level design rule conflict with another printed circuit board layout design. In some embodiments, the printed circuit board layout tool can identify the conflict by performing a design rule check on the virtual product model using the new system-level design rule to identify other layout design or a mechanical design conflicts with the new system-level design rule. The printed circuit board layout tool also can identify the conflict by performing a design rule check on the layout design developed by printed circuit board layout tool using system-level design rules generated by the shared management system, other printed circuit board layout tools, or the mechanical design system. The printed circuit board layout tool can generate the notification messages to inform the shared management system, the other printed circuit board layout tools, or the mechanical design system of the conflict. In some embodiments, the printed circuit board layout tool can identify changes that, if made to other layout designs or mechanical designs, would resolve the conflict, such as moving a component or trace to a different portion of the layout design. The printed circuit board layout tool can generate the notification messages to inform the shared management system, the other printed circuit board layout tools, or the mechanical design system of the suggested changes that would resolve the conflict.

In a block 605, the computing system implementing the printed circuit board layout tool can transmit the modifications to the virtual product model, the system-level design rule, and/or the notification message to a shared management system for distribution to other product design tools. The shared management system, as discussed above, can utilize the modifications to the virtual product model and the new system-level design rule to update the shared product model for the other product design tools, allowing all of the tools to have the same information during the development process.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
distributing, by a computing device, virtual product models to multiple printed circuit board layout tools, wherein the virtual product models each correspond to a shared product model describing a product having an electronic device with multiple printed circuit boards, wherein the printed circuit board layout tools are configured to separately modify the corresponding virtual product models to generate layout designs for the multiple print circuit boards in the product and to generate at least one system-level design rule describing a physical limitation for the electronic device based on a constraint in at least one of the layout designs for the multiple print circuit boards;
updating, by the computing system, the shared product model based, at least in part, on the modifications to at least one of the virtual product models by the printed circuit board layout tools; and
transmitting, by the computing system, a notification to at least one of the printed circuit board layout tools when the updated shared product model conflicts with the physical limitation for the electronic device described in the at least one system-level design rule.

2. The method of claim 1, wherein the system-level design rule describes the physical limitation for the electronic device based on a physical constraint or an electrical constraint in at least one of the layout designs for the multiple print circuit boards.

3. The method of claim 1, wherein the modification of the virtual product models by the print circuit board layout tools generates the notification for transmission to the at least one of the printed circuit board layout tools.

4. The method of claim 1, further comprising:
performing, by the computing system, a system-level design rule check to compare the updated shared product model to the physical limitation for the electronic device described in the at least one system-level design rule; and
generating, by the computing system, the notification to at least one of the printed circuit board layout tools when the system-level design rule check determines the updated shared product model conflicts with the physical limitation for the electronic device described in the at least one system-level design rule.

5. The method of claim 1, wherein the notification is configured to identify which portion of the electronic device is in a conflict with the physical limitation for the electronic device and identify a suggested alteration for at least one of the printed circuit board layout tools to perform to resolve the conflict.

6. The method of claim 1, further comprising transmitting, by the computing system, at least the modified portion of the updated shared product model to one or more of the multiple printed circuit board layout tools, wherein the printed circuit board layout tools are configured to modify the corresponding virtual product model based on the at least the modified portion of the updated shared product model.

7. The method of claim 1, further comprising:
receiving, by the computing system, a mechanical design from a mechanical system, wherein the mechanical design describes a physical structure of the product to include an electronic device comprising the multiple printed circuit boards; and
incorporating, by the computing system, the mechanical design into the shared product model for distribution to the printed circuit board layout tools as the virtual product models.

8. An apparatus comprising at least one computer-readable memory device storing instructions configured to cause one or more processing devices to perform operations comprising:
distributing virtual product models to multiple printed circuit board layout tools, wherein the virtual product models each correspond to a shared product model describing a product having an electronic device with multiple printed circuit boards, wherein the printed circuit board layout tools are configured to separately modify the corresponding virtual product models to generate layout designs for the multiple print circuit boards in the product and to generate at least one system-level design rule describing a physical limitation for the electronic device based on a constraint in at least one of the layout designs for the multiple print circuit boards;
updating the shared product model based, at least in part, on the modifications to at least one of the virtual product models by the printed circuit board layout tools; and
transmitting a notification to at least one of the printed circuit board layout tools when the updated shared product model conflicts with the physical limitation for the electronic device described in the at least one system-level design rule.

9. The apparatus of claim 8, wherein the system-level design rule describes the physical limitation for the electronic device based on a physical constraint or an electrical constraint in at least one of the layout designs for the multiple print circuit boards.

10. The apparatus of claim 8, wherein the modification of the virtual product models by the print circuit board layout tools generates the notification for transmission to the at least one of the printed circuit board layout tools.

11. The apparatus of claim 8, wherein the instructions configured to cause the one or more processing devices to perform operations further comprising
performing a system-level design rule check to compare the updated shared product model to the physical limitation for the electronic device described in the at least one system-level design rule; and
generating the notification to at least one of the printed circuit board layout tools when the system-level design rule check determines the updated shared product model conflicts with the physical limitation for the electronic device described in the at least one system-level design rule.

12. The apparatus of claim 8, wherein the notification is configured to identify which portion of the electronic device is in a conflict with the physical limitation for the electronic device and identify a suggested alteration for at least one of the printed circuit board layout tools to perform to resolve the conflict.

13. The apparatus of claim 8, wherein the instructions configured to cause the one or more processing devices to perform operations further comprising transmitting at least the modified portion of the updated shared product model to one or more of the multiple printed circuit board layout tools, wherein the printed circuit board layout tools are configured to modify the corresponding virtual product model based on the at least the modified portion of the updated shared product model.

14. The apparatus of claim 8, wherein the instructions configured to cause the one or more processing devices to perform operations further comprising:
receiving a mechanical design from a mechanical system, wherein the mechanical design describes a physical structure of the product to include an electronic device comprising the multiple printed circuit boards; and
incorporating the mechanical design into the shared product model for distribution to the printed circuit board layout tools as the virtual product models.

15. A system comprising:
a memory device configured to store machine-readable instructions; and
a computing system including one or more processing devices, in response to executing the machine-readable instructions, configured to
distribute virtual product models to multiple printed circuit board layout tools, wherein the virtual product models each correspond to a shared product model describing a product having an electronic device with multiple printed circuit boards, wherein the printed circuit board layout tools are configured to separately modify the corresponding virtual product models to generate layout designs for the multiple print circuit boards in the product and to generate at least one system-level design rule describing a physical limitation for the electronic device based on a constraint in at least one of the layout designs for the multiple print circuit boards;
update the shared product model based, at least in part, on the modifications to at least one of the virtual product models by the printed circuit board layout tools; and
transmit a notification to at least one of the printed circuit board layout tools when the updated shared product model conflicts with the physical limitation for the electronic device described in the at least one system-level design rule.

16. The system of claim 15, wherein the system-level design rule describes the physical limitation for the electronic device based on a physical constraint or an electrical constraint in at least one of the layout designs for the multiple print circuit boards.

17. The system of claim 15, wherein the modification of the virtual product models by the print circuit board layout tools generates the notification for transmission to the at least one of the printed circuit board layout tools.

18. The system of claim 15, wherein the one or more processing devices, in response to executing the machine-readable instructions, are configured to:
perform a system-level design rule check to compare the updated shared product model to the physical limitation for the electronic device described in the at least one system-level design rule; and
generate the notification to at least one of the printed circuit board layout tools when the system-level design rule check determines the updated shared product model conflicts with the physical limitation for the electronic device described in the at least one system-level design rule.

19. The system of claim 15, wherein the notification is configured to identify which portion of the electronic device is in a conflict with the physical limitation for the electronic device and identify a suggested alteration for at least one of the printed circuit board layout tools to perform to resolve the conflict.

20. The system of claim 15, wherein the one or more processing devices, in response to executing the machine-readable instructions, are configured to transmit at least the modified portion of the updated shared product model to one or more of the multiple printed circuit board layout tools, wherein the printed circuit board layout tools are configured to modify the corresponding virtual product model based on the at least the modified portion of the updated shared product model.
